(19) United States
(12) Patent Application Publication
(10) Pub. No.: US 2020/0140664 A1
(43) Pub. Date: May 7, 2020

(54) RUBBER COMPOSITION FOR TIRE TREAD, AND PNEUMATIC TIRE

(71) Applicant: Toyo Tire Corporation, Itami-shi (JP)

(72) Inventor: Yuma Nishikawa, Itami-shi (JP)

(73) Assignee: Toyo Tire Corporation, Itami-shi (JP)

(21) Appl. No.: 16/653,081

(22) Filed: Oct. 15, 2019

(30) Foreign Application Priority Data
Nov. 7, 2018 (JP) 2018-209833

(51) Int. Cl. C08L 9/08; C08K 3/36; B60C 1/00

(52) U.S. Cl. CPC C08L 9/08; C08G 2261/724; B60C 1/0016; C08K 3/36

(57) ABSTRACT

Disclosed is a rubber composition for a tire tread comprising 1 to 30 parts by mass of a hydrogenated terpene-phenolic resin per 100 parts by mass of a diene rubber component containing 30 parts by mass or more of emulsion-polymerized styrene-butadiene rubber having a glass transition temperature of −50° C. or lower. Disclosed is a pneumatic tire having a tread comprising the rubber composition.

### CROSS-REFERENCE TO RELATED APPLICATIONS

This application is based upon and claims the benefit of priority from the prior Japanese Patent Application No. 2018-209833, filed on Nov. 7, 2018; the entire contents of which are incorporated herein by reference.

### BACKGROUND

### 1. Field of the Invention

The present invention relates to a rubber composition for a tire tread, and a pneumatic tire using the rubber composition.

### 2. Description of Related Art

Pneumatic tire is required to improve high grip performance (that is, wet grip performance) on wet road surface. Furthermore, a rubber composition forming a tread is also required to have abrasion resistance for life elongation of a tire.

WO2016/104144 (US 2017/341468 A1) proposes to concurrently use a specific hydrogenated terpene aromatic resin and a specific inorganic filler in order to improve wet grip performance, dry grip performance and durability in good balance. JP-A-2015-165000 (US 2015/218305 A1) proposes to add a partially hydrogenated phenolic resin obtained by selectively hydrogenating a double bond other than an aromatic ring of a phenolic resin to a diene rubber component containing styrene-butadiene rubber in order to achieve both grip performance and abrasion resistance. JP-A-2008-169296 (US 2010/113703 A1) proposes to concurrently use a hydrogenated terpene-phenolic resin having a softening point of 130° C. or higher and a C9 resin having a softening point of 130 to 190° C. in order to improve initial grip performance and running stability. However, it has not been known that abrasion resistance can be improved while improving wet grip performance, by adding a hydrogenated terpene-phenolic resin to an emulsion-polymerized styrene-butadiene rubber having a specific glass transition temperature.

### SUMMARY

One or more of aspects of the present invention are directed to provide a rubber composition for a tire tread, that can improve wet grip performance and abrasion resistance.

The rubber composition for a tire tread according to one aspect of the present invention comprises 1 to 30 parts by mass of a hydrogenated terpene-phenolic resin per 100 parts by mass of a diene rubber component containing 30 parts by mass or more of emulsion-polymerized styrene-butadiene rubber having a glass transition temperature of −50° C. or lower.

The pneumatic tire according to one aspect of the present invention has a tread comprising the rubber composition.

### DESCRIPTION OF EMBODIMENTS

The rubber composition according to the present embodiment comprises a diene rubber component and a hydrogenated terpene-phenolic resin added thereto.

The diene rubber component includes an emulsion-polymerized styrene-butadiene rubber (E-SBR) (hereinafter referred to as “emulsion-polymerized SBR”) having a glass transition temperature (Tg) of −50° C. or lower. When the emulsion-polymerized SBR having low glass transition temperature is used, the improvement effect of wet grip performance is achieved and additionally abrasion resistance can be improved, in the combination with a hydrogenated terpene-phenolic resin.

The lower limit of the glass transition temperature of the emulsion-polymerized SBR is not particularly limited, and is, for example, −70° C. or higher. The glass transition temperature used herein is a value measured using differential scanning calorimetry (DSC) according to JIS K7121 (temperature rising rate: 20° C./min).

The emulsion-polymerized SBR is not particularly limited, and generally uses an emulsion-polymerized SBR having a styrene content (St) of 10 to 50% by mass and a vinyl content (Vi) in a butadiene moiety of 10 to 30% by mole. The styrene content is preferably 20 to 30% by mass, and the vinyl content in a butadiene moiety is preferably 10 to 20% by mole. When the styrene-butadiene rubber having low styrene content and vinyl content is used, the improvement effect of abrasion resistance can be enhanced. The vinyl content in a butadiene moiety is an amount of a vinyl bond (sometimes called vinyl bond amount) occupied in a butadiene component constituting SBR and is represented by molar fraction to the butadiene component. The styrene content and vinyl content can be measured by FT-IR (Fourier Transform Infrared Spectroscopy) method. In more detail, BR, NR and IR are obtained by Morero method, and SBR is obtained by Hampton-Morero method.

The emulsion-polymerized SBR is added in an amount of 30 parts by mass or more in 100 parts by mass of the diene rubber component. The addition amount of the emulsion-polymerized SBR is preferably 50 parts by mass or more. The diene rubber component may be the emulsion-polymerized SBR alone (that is, the addition amount of the emulsion-polymerized SBR is 100 parts by mass), but other diene rubber may be added together with the emulsion-polymerized SBR. The upper limit of the addition amount of the emulsion-polymerized SBR is not particularly limited, and is generally 90 parts by mass or less and preferably 70 parts by mass or less.

The other diene rubber used together with the emulsion-polymerized SBR is not particularly limited. Examples of the other diene rubber that can be used include natural rubber (NR), synthetic isoprene rubber (IR), butadiene rubber (BR), styrene-butadiene rubber (SBR) other than the emulsion-polymerized SBR, styrene-isoprene copolymer rubber, butadiene-isoprene copolymer rubber and styrene-isoprene-butadiene copolymer rubber. Those rubbers may be alone or as mixtures of two or more kinds thereof. Of those other diene rubbers, diene rubber having a glass transition temperature of −50° C. or lower is preferably used, and specifically, for example, natural rubber and/or butadiene rubber are preferably used. The addition amount of the natural rubber and/or butadiene rubber is 70 parts by mass or less and preferably 50 parts by mass or less, in 100 parts by mass of the diene rubber component.

In the present invention, a hydrogenated terpene-phenolic resin is added together with the emulsion-polymerized SBR. When the hydrogenated terpene-phenolic resin is added, wet grip performance can be improved. Furthermore, it is considered that the hydrogenated terpene-phenolic resin has good compatibility with the emulsion-polymerized SBR, and as a result, abrasion resistance is improved.

The hydrogenated terpene-phenolic resin is obtained by hydrogenating (that is, hydrogen addition) a terpene-phenolic resin. The hydrogenated terpene-phenolic resin is preferably a resin obtained by hydrogenating a double bond other than an aromatic ring, together with a double bond of the aromatic ring, of a terpene-phenolic resin. Hydrogenation rate is not particularly limited, but is, for example, preferably 70% or more and more preferably 80 to 100%. The hydrogenation rate used herein is calculated from each integrated value of a double bond-derived peak by proton NMR. Specifically, in an integrated value of a terpene double bond-derived peak in the vicinity of 5 to 6 ppm and an integrated value of a phenol-derived peak in 6.5 to 7.5 ppm, when the total of those integrated values before hydrogenation is A and the total of those values after hydrogenation is B, the hydrogenation rate is calculated by the following formula:

Hydrogenation rate (%)={(A−B)/A}×100

The hydrogenated terpene-phenolic resin having a hydroxyl value of 25 to 150 mgKOH/g is preferably used. The hydroxyl value is preferably 50 mgKOH/g or more, and is preferably 70 mgKOH/g or less. When the hydroxyl value of the hydrogenated terpene-phenolic resin is 25 mg/KOH/g or more, the improvement effect of abrasion resistance performance can be enhanced. Furthermore, when the hydroxyl value is 150 mgKOH/g or less, the improvement effect of wet grip performance can be enhanced.

The hydroxyl value of the hydrogenated terpene-phenolic resin is measured according to JIS K0070 Neutralization Analysis.

The hydrogenated terpene-phenolic resin having a softening point of 100 to 170° C. is preferably used. When the softening point of the hydrogenated terpene-phenolic resin is 100° C. or higher, the improvement effect of wet grip performance can be enhanced. Furthermore, when the softening point is 170° C. or lower, the resin is easy to be mixed with a rubber when kneading, and performance exhibition effect of a vulcanized rubber is high. The softening point used herein is measured according to JIS K6220-1: 2015.

The addition amount of the hydrogenated terpene-phenolic resin is preferably I to 30 parts by mass and more preferably 3 to 25 parts by mass, per 100 parts by mass of the diene rubber component.

The rubber composition according to the present embodiment can further contain various additives that are generally used in a rubber composition for a tire, such as, a reinforcing filler, a silane coupling agent, oil, stearic acid, zinc oxide, an age resister, a processing aid, a vulcanizing agent or a vulcanization accelerator, other than the above-described components.

Examples of the reinforcing filler include silica and carbon black. Silica may be used alone, carbon black may be used alone, and a mixture of silica and carbon black may be used.

The silica is not particularly limited. For example, wet silica such as wet precipitated silica or wet gelled silica may be used. The addition amount of the silica is not particularly limited, and may be 10 to 120 parts by mass, may be 40 to 100 parts by mass and may also be 60 to 100 parts by mass, per 100 parts by mass of the diene rubber component. In the present embodiment, silica is preferably used as a main reinforcing filler. For example, the amount of the silica in the reinforcing filler is preferably more than 50% by mass and more preferably 70% by mass or more, based on the mass of the reinforcing filler.

The carbon black is not particularly limited, and can use the conventional various kinds of carbon black, such as SAF grade (N100 Series), ISAF grade (N200 Series), HAF grade (N300 Series) and FEF grade (N500 Series) (those are ASTM grade). The carbon black of each grade may be used in one kind alone or as mixtures of two or more kinds thereof. The addition amount of the carbon black is not particularly limited, and may be 1 to 100 parts by mass, may be 1 to 50 parts by mass and may also be 2 to 15 parts by mass, per 100 parts by mass of the diene rubber component.

When silica is used as the reinforcing filler, a silane coupling agent is preferably added. Examples of the saline coupling agent include sulfide silane and mercaptosilane. The addition amount of the silane coupling agent is not particularly limited, and is, for example, 2 to 20% by mass based on the addition amount of silica.

The vulcanizing agent preferably uses sulfur. The addition amount of the vulcanizing agent is not particularly limited, and is, for example, 0.1 to 10 parts by mass and may also be 0.5 to 5 parts by mass, per 100 parts by mass of the diene rubber component. Examples of the vulcanization accelerator include various vulcanization accelerators such as sulfenamide type, thiuram type, thiazole type and guanidine type. Those vulcanization accelerators can be used in one kind alone or as mixtures of two or more kinds thereof. The addition amount of the vulcanization accelerator is not particularly limited, and is, for example, 0.1 to 7 parts by mass and may also be 0.5 to 5 parts by mass, per 100 parts by mass of the diene rubber component.

The rubber composition according to the present embodiment can be prepared by kneading the necessary components according to the conventional method using a mixing machine generally used, such as Banbury mixer, a kneader or rolls. Specifically, additives other than a vulcanizing agent and a vulcanization accelerator are added to a diene rubber component together with a hydrogenated terpene-phenolic resin, followed by mixing, in a first mixing step (non-processing kneading step). A vulcanizing agent and a vulcanization accelerator are then added to the mixture thus obtained, followed by mixing, in a final mixing step (processing kneading step). Thus, an unvulcanized rubber composition can be prepared.

The rubber composition according to the present embodiment can be used in, for example, a tread part of tires for various uses, such as for passenger cars or for heavy load of trucks or buses. In other words, the pneumatic tire according to the present embodiment has a tread comprising the rubber composition.

The method for manufacturing a pneumatic tire according to the present embodiment comprises preparing an unvulcanized tread rubber for a tire using the rubber composition by a rubber extruder or the like, combining the unvulcanized tread rubber with other tire members to prepare an unvulcanized tire (green tire), and vulcanization molding the unvulcanized tire at a temperature of, for example, 140 to 180° C., thereby obtaining a pneumatic tire. The tread rubber of a pneumatic tire includes a tread rubber comprising a two-layered structure of a cap rubber and a base rubber, and a single layer structure in which those are integrated. The rubber composition is preferably used in a rubber constituting a ground contact surface. That is, it is preferred that when the tread rubber has a single layer structure, the tread rubber comprises the rubber composition, and when the tread rubber has a two-layered structure, the cap rubber comprises the rubber composition.

### EXAMPLES

Examples of the present embodiment are described below, but the present invention is not construed as being limited to those examples.

Chemicals used in examples and comparative examples are as follows.

E-SBR1: “SBR1723” (emulsion-polymerized SBR, glass transition temperature: −53° C., styrene content: 24% by mass, vinyl content in butadiene moiety: 15% by mole, oil-extended rubber: containing oil content of 37.5 parts by mass per 100 parts by mass of rubber solid component) manufactured by JSR Corporation

E-SBR2: “SBR1502” (emulsion-polymerized SBR, glass transition temperature: −66° C., styrene content: 24% by mass, vinyl content in butadiene moiety: 18% by mole) manufactured by JSR Corporation

E-SBR3: “NIPOL 9548” (emulsion-polymerized SBR, glass transition temperature: −40° C., styrene content: 35% by mass, vinyl content in butadiene moiety: 18% by mole, oil-extended rubber: containing oil content of 37.5 parts by mass per 100 parts by mass of rubber solid component) manufactured by Zeon Corporation

S-SBR: “HPR350” (solution-polymerized SBR, glass transition temperature: −35° C., styrene content: 20% by mass, vinyl content in butadiene moiety: 55% by mole) manufactured by JSR Corporation

BR: Butadiene rubber, “BR150B” manufactured by Ube Industries, Ltd.

NR: Natural rubber, RSS#3

Silica: “Ultrasil 7000GR” manufactured by Evonik Degussa

Silane coupling agent: “Si69” manufactured by Evonik Degussa

Carbon black: “SEAST 3” manufactured by Tokai Carbon Co., Ltd.

Zinc oxide: “Zinc Flower #1” manufactured by Mitsui Mining & Smelting Co., Ltd.

Age resister: “NOCRAC 6C” manufactured by Ouchi Shinko Chemical Industrial Co., Ltd.

Stearic acid: “LUNAC S20” manufactured by Kao Corporation

Processing aid: “AKTIPLAST PP” manufactured by Lanxess

Oil: “PROCESS NC140” manufactured by JX Nippon Oil & Energy Corporation

Sulfur: “POWDERED SILICA” manufactured by Tsurumi Chemical Industry Co., Ltd.

Vulcanization accelerator 1: “NOCCELER D” manufactured by Ouchi Shinko Chemical Industrial Co., Ltd.

Vulcanization accelerator 2: “SOXINOL CZ” manufactured by Sumitomo Chemical Co., Ltd.

Petroleum-based resin: “PETROTAC 90” manufactured by Tosoh Corporation

Hydrogenated terpene-phenolic resin 1: “YS POLYSTAR UH115” (hydrogenation rate: 92%, hydroxyl value: 25 mgKOH/g, softening point: 115° C.) manufactured by Yasuhara Chemical Co., Ltd.

Hydrogenated terpene-phenolic resin 2: 100 g of a terpene-phenolic resin (“YS POLYSTAR T160” manufactured by Yasuhara Chemical Co., Ltd), 400 g of isopropyl alcohol and 2.0 g of 5% palladium-supported powdery alumina catalyst were placed in a reaction vessel, the reaction vessel was closed and the atmosphere in the reaction vessel was substituted with nitrogen gas. Hydrogen gas was then introduced into the reaction vessel under a pressure of 0.98 MPa. Heating and stirring were performed, and when the temperature reached 160° C., the pressure of hydrogen was set to 7.8 MPa, and the reaction was conducted for 5 hours while maintaining the pressure of 7.8 MPa. Thus, hydrogenated terpene-phenolic resin 2 (hydrogenation rate: 80%, hydroxyl value: 60 mgKOH/g, softening point: 166° C.) was obtained.

Hydrogenated terpene-phenolic resin 3: Hydrogenated terpene-phenolic resin 3 (hydrogenation rate: 90%, hydroxyl value: 130 mgKOH/g, softening point: 150° C.) was obtained in the same synthesis method as in the hydrogenated terpene-phenolic resin 2 using a terpene-phenolic resin (“YS POLYSTAR S145” manufactured by Yasuhara Chemical Co., Ltd.), except for changing the reaction time to 10 hours.

Evaluation methods in the examples and comparative examples are as follows.

Wet grip performance: Loss factor tan δ was measured under the conditions of frequency: 10 Hz, static strain: 10%, dynamic strain: 1% and temperature: 0° C. using a viscoelasticity tester manufactured by Toyo Seiki Seisaku-Sho Ltd., and was indicated by an index as the value of Comparative Example 1 in Table 1, the value of Comparative Example 3 in Table 2, the value of Comparative Example 5 in Table 3, the value of Comparative Example 6 in Table 4 and the value of Comparative Example 8 in Table 5 being 100, respectively. The wet grip performance is excellent as the index is large.

Abrasion resistance: Abrasion loss was measured under the conditions of load: 40N and slip ratio: 30% according to JIS K6264 using Lamboum abrasion tester manufactured by Iwamoto Seisakusho, and was indicated by an index as an inverse number of measurement value as the value of Comparative Example 1 in Table 1, the value of Comparative Example 3 in Table 2, the value of Comparative Example 5 in Table 3, the value of Comparative Example 6 in Table 4 and the value of Comparative Example 8 in Table 5 being 100, respectively. The abrasion resistance is excellent as the index is large.

### First Example

Banbury mixer was used. Compounding additives excluding sulfur and a vulcanization accelerator were added to a diene rubber component according to the formulations (parts by mass) shown in Table 1 below, followed by kneading, in a first mixing step (discharge temperature: 160° C.). Sulfur and a vulcanization accelerator were then added to the kneaded material, followed by kneading, in a final step (discharge temperature: 90° C.). Thus, rubber compositions were prepared. Each rubber composition obtained was vulcanized at 160° C. for 30 minutes to prepare a test piece, and wet grip performance and abrasion resistance of the test piece were evaluated.

TABLE 1

| | Com. Ex. 1 | Com. Ex. 2 | Ex. 1 | Ex. 2 | Ex. 3 | Ex. 4 | Ex. 5 |
|---|---|---|---|---|---|---|---|
| Formulation (parts by mass) | | | | | | | |
| E-SBR1 (*1) | 82.5 (60) | 82.5 (60) | 82.5 (60) | 82.5 (60) | 82.5 (60) | 82.5 (60) | 82.5 (60) |
| NR | 40 | 40 | 40 | 40 | 40 | 40 | 40 |
| Silica | 100 | 100 | 100 | 100 | 100 | 100 | 100 |
| Silane coupling agent | 10 | 10 | 10 | 10 | 10 | 10 | 10 |
| Carbon black | 5 | 5 | 5 | 5 | 5 | 5 | 5 |
| Oil | 7.5 | 7.5 | 7.5 | 7.5 | 7.5 | 7.5 | 7.5 |
| Stearic acid | 2 | 2 | 2 | 2 | 2 | 2 | 2 |
| Zinc oxide | 3 | 3 | 3 | 3 | 3 | 3 | 3 |
| Age resister | 2 | 2 | 2 | 2 | 2 | 2 | 2 |
| Processing aid | 5 | 5 | 5 | 5 | 5 | 5 | 5 |
| Hydrogenated | — | — | 5 | — | — | 10 | 25 |
| terpene-phenolic resin 1 | | | | | | | |
| Hydrogenated | — | — | — | 5 | — | — | — |
| terpene-phenolic resin 2 | | | | | | | |
| Hydrogenated | — | — | — | — | 5 | — | — |
| terpene-phenolic resin 3 | | | | | | | |
| Petroleum-based resin | — | 5 | — | — | — | — | — |
| Sulfur | 2 | 2 | 2 | 2 | 2 | 2 | 2 |
| Vulcanization accelerator 1 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 |
| Evaluation | | | | | | | |
| Wet grip performance | 100 | 113 | 111 | 112 | 108 | 123 | 136 |
| Abrasion resistance | 100 | 99 | 112 | 114 | 109 | 120 | 121 |

(*1): Value in parenthesis in the table is the amount as rubber content.

The results obtained are shown in Table 1 above. As compared with Comparative Example 1 that is a control, Comparative Example 2 in which a petroleum-based resin was added was that wet grip performance was improved, but the improvement effect of abrasion resistance was not obtained. On the other hand, Examples 1 to 5 in which a hydrogenated terpene-phenolic resin was added were that remarkable improvement effect was observed in both wet grip performance and abrasion resistance, as compared with Comparative Example 1.

### Second Example

Rubber compositions were prepared according to the formulations (parts by mass) shown in Table 2 below in the same manner as in First Example, and each rubber composition obtained was vulcanized at 160° C. for 30 minutes to prepare a test piece, and wet grip performance and abrasion resistance of the test piece were evaluated.

TABLE 2

| | Com. Ex. 3 | Com. Ex. 4 | Ex. 6 | Ex. 7 |
|---|---|---|---|---|
| Formulation (parts by mass) | | | | |
| E-SBR1 | 68.75 | 68.75 | 68.75 | 68.75 |
| (*1) | (50) | (50) | (50) | (50) |
| BR | 40 | 40 | 40 | 40 |
| NR | 10 | 10 | 10 | 10 |
| Silica | 100 | 100 | 100 | 100 |
| Silane coupling agent | 10 | 10 | 10 | 10 |
| Carbon black | 5 | 5 | 5 | 5 |
| Oil | 11.25 | 11.25 | 11.25 | 11.25 |
| Stearic acid | 2 | 2 | 2 | 2 |
| Zinc oxide | 3 | 3 | 3 | 3 |
| Age resister | 2 | 2 | 2 | 2 |
| Processing aid | 5 | 5 | 5 | 5 |
| Hydrogenated terpene- | — | — | 5 | — |
| phenolic resin 2 | | | | |
| Hydrogenated terpene- | — | — | — | 5 |
| phenolic resin 3 | | | | |
| Petroleum-based resin | — | 5 | — | — |
| Sulfur | 2 | 2 | 2 | 2 |
| Vulcanization accelerator 1 | 1.5 | 1.5 | 1.5 | 1.5 |
| Vulcanization accelerator 2 | 1.5 | 1.5 | 1.5 | 1.5 |
| Evaluation | | | | |
| Wet grip performance | 100 | 117 | 120 | 119 |
| Abrasion resistance | 100 | 97 | 121 | 117 |

(*1): Value in parenthesis in the table is the amount as rubber content.

The results obtained are shown in Table 2 above. Similar to First Example, as compared with Comparative Example 3 that is a control, Comparative Example 4 in which a petroleum-based resin was added was that wet grip performance was improved, but the improvement effect of abrasion resistance was not obtained. On the other hand, Examples 6 and 7 in which a hydrogenated terpene-phenolic resin was added were that remarkable improvement effect was observed in both wet grip performance and abrasion resistance as compared with Comparative Example 3.

### Third Example

Rubber compositions were prepared according to the formulations (pans by mass) shown in Table 3 below in the same manner as in First Example, and each rubber composition obtained was vulcanized at 160° C. for 30 minutes to prepare a test piece, and wet grip performance and abrasion resistance of the test piece were evaluated.

TABLE 3

| | Com. Ex. 5 | Ex. 8 | Ex. 9 |
|---|---|---|---|
| Formulation (parts by mass) | | | |
| E-SBR2 | 60 | 60 | 60 |
| NR | 40 | 40 | 40 |
| Silica | 100 | 100 | 100 |
| Silane coupling agent | 10 | 10 | 10 |
| Carbon black | 5 | 5 | 5 |
| Oil | 30 | 30 | 30 |
| Stearic acid | 2 | 2 | 2 |
| Zinc oxide | 3 | 3 | 3 |
| Age resister | 2 | 2 | 2 |
| Processing aid | 5 | 5 | 5 |
| Hydrogenated terpene-phenolic resin 2 | — | 5 | — |
| Hydrogenated terpene-phenolic resin 3 | — | — | 5 |
| Sulfur | 2 | 2 | 2 |
| Vulcanization accelerator 1 | 1.5 | 1.5 | 1.5 |
| Vulcanization accelerator 2 | 1.5 | 1.5 | 1.5 |
| Evaluation | | | |
| Wet grip performance | 100 | 116 | 112 |
| Abrasion resistance | 100 | 118 | 117 |

The results obtained are shown in Table 3 above. Even when emulsion-polymerized SBR having a glass transition temperature of −66° C. was used, similar to First Example and Second Example, Examples 8 and 9 in which a hydrogenated terpene-phenolic resin was added were that remarkable improvement effect was observed in both wet grip performance and abrasion resistance as compared with Comparative Example 5 that is a control.

### First Comparative Example

Rubber compositions were prepared according to the formulations (parts by mass) shown in Table 4 below in the same manner as in First Example, and each rubber composition obtained was vulcanized at 160° C. for 30 minutes to prepare a test piece, and wet grip performance and abrasion resistance of the test piece were evaluated.

TABLE 4

| | Com. Ex. 6 | Com. Ex. 7 |
|---|---|---|
| Formulation (parts by mass) | | |
| E-SBR3 | 82.5 | 82.5 |
| (*2) | (60) | (60) |
| NR | 40 | 40 |
| Silica | 100 | 100 |
| Silane coupling agent | 10 | 10 |
| Carbon black | 5 | 5 |
| Oil | 7.5 | 7.5 |
| Stearic acid | 2 | 2 |
| Zinc oxide | 3 | 3 |
| Age resister | 2 | 2 |
| Processing aid | 5 | 5 |
| Hydrogenated terpene-phenolic resin 1 | — | 5 |
| Sulfur | 2 | 2 |
| Vulcanization accelerator 1 | 1.5 | 1.5 |
| Vulcanization accelerator 2 | 1.5 | 1.5 |
| Evaluation | | |
| Wet grip performance | 100 | 108 |
| Abrasion resistance | 100 | 99 |

(*2): Value in parenthesis in the table is the amount as rubber content.

### Second Comparative Example

Rubber compositions were prepared according to the formulations (parts by mass) shown in Table 5 below in the same manner as in First Example, and each rubber composition obtained was vulcanized at 160° C. for 30 minutes to prepare a test piece, and wet grip performance and abrasion resistance of the test piece were evaluated.

TABLE 5

| | Com. Ex. 8 | Com. Ex. 9 |
|---|---|---|
| Formulation (parts by mass) | | |
| S-SBR | 60 | 60 |
| NR | 40 | 40 |
| Silica | 100 | 100 |
| Silane coupling agent | 10 | 10 |
| Carbon black | 5 | 5 |
| Oil | 30 | 30 |
| Stearic acid | 2 | 2 |
| Zinc oxide | 3 | 3 |
| Age resister | 2 | 2 |
| Processing aid | 5 | 5 |
| Hydrogenated terpene-phenolic resin 1 | — | 5 |
| Sulfur | 2 | 2 |
| Vulcanization accelerator 1 | 1.5 | 1.5 |
| Vulcanization accelerator 2 | 1.5 | 1.5 |
| Evaluation | | |
| Wet grip performance | 100 | 107 |
| Abrasion resistance | 100 | 102 |

As shown in Tables 1 to 3, when a hydrogenated terpene-phenolic resin was added to the emulsion-polymerized SBR having a glass transition temperature of −50° C. or lower, remarkable improvement effect was observed in abrasion resistance in addition to wet grip performance. On the other hand, as shown in Table 4, in the emulsion-polymerized SBR having a glass transition temperature of −40° C., the improvement effect was observed in wet grip performance by adding a hydrogenated terpene-phenolic resin, but the improvement effect was not observed in abrasion resistance. Furthermore, as shown in Table 5, in the solution-polymerized SBR, the improvement effect was observed in wet grip performance by adding a hydrogenated terpene-phenolic resin, but the improvement effect was not observed in abrasion resistance.

Some embodiments have been explained above, and these embodiment are cited as examples and do not intend to limit the scope of the invention. These embodiments may be achieved in other various manners, and various kinds of omission, replacement and alterations may occur within a scope not departing from the gist of the invention. These embodiments and modifications thereof are included in claims or the gist thereof as well as included in the inventions described in claims and the range of equivalency of the claims.

What is claimed is:

1. A rubber composition for a tire tread comprising 1 to 30 parts by mass of a hydrogenated terpene-phenolic resin per 100 parts by mass of a diene rubber component containing 30 parts by mass or more of emulsion-polymerized styrene-butadiene rubber having a glass transition temperature of −50° C. or lower. The rubber composition for a tire tread according to claim 1, wherein the hydrogenated terpene-phenolic resin has a hydroxyl value of 25 to 150 mgKOH/g. The rubber composition for a tire tread according to claim 2, wherein the hydroxyl value of the hydrogenated terpene-phenolic resin is 50 to 70 mgKOH/g.

4. The rubber composition for a tire tread according to claim 1, wherein the hydrogenated terpene-phenolic resin has a softening point of 100 to 170° C.

5. The rubber composition for a tire tread according to claim 2, wherein the hydrogenated terpene-phenolic resin has a softening point of 100 to 170° C.

6. The rubber composition for a tire tread according to claim 1, wherein the emulsion-polymerized styrene-butadiene rubber has a styrene content of 10 to 50% by mass and a vinyl content in a butadiene moiety of 10 to 30% by mole.

7. The rubber composition for a tire tread according to claim 1, wherein the hydrogenated terpene-phenolic resin comprises a terpene-phenolic resin in which a double bond other than an aromatic ring and a double bond of an aromatic ring are hydrogenated. h. The rubber composition for a tire tread according to claim 1, wherein the hydrogenated terpene-phenolic resin has a hydrogenation rate of 70% or more.

9. The rubber composition for a tire tread according to claim 1, further comprising 10 to 120 parts by mass of silica per 100 parts by mass of the diene rubber component.

10. A pneumatic tire having a tread comprising the rubber composition according to claim 1.
